(19) United States
(12) Patent Application Publication
(10) Pub. No.: US 2024/0062490 A1
(43) Pub. Date: Feb. 22, 2024

(54) SYSTEM AND METHOD FOR CONTEXTUALIZED SELECTION OF OBJECTS FOR PLACEMENT IN MIXED REALITY

(71) Applicant: Urbanoid Inc., Montreal (CA)

(72) Inventors: Pascal MAEDER, Montreal (CA); Hafsa ENNAJARI, Montreal (CA); Leonid REINOSO MEDINA, La Habana (CU); Akinlolu Oluwabusayo OJO, Lachine (CA)

(21) Appl. No.: 18/451,175

(22) Filed: Aug. 17, 2023

Related U.S. Application Data
(60) Provisional application No. 63/371,823, filed on Aug. 18, 2022.

(51) Int. Cl. G06T 19/00; G06T 19/20

(52) U.S. Cl. CPC G06T 19/006; G06T 19/20; G06T 2219/2004; G06V 20/20

(57) ABSTRACT

A system and method is provided for contextualizing and selecting objects for placement in digital environments, specifically, in mixed reality (MR) environments. The proposed systems and methods embed personalized and customized content in the user's view of the physical environment in real time. The systems and methods include a contextual data harvesting process related to the user's physical surroundings. The gathered data about the user environment and the set of available objects are then processed using machine learning (ML) models to infer a relevant object to place on the selected placement space. Further, the present systems and methods include displaying the selected object in the MR environment. Systems and methods for training ML models for contextualizing and selecting objects for placement in mixed reality environments are also provided.

### CROSS-REFERENCE TO RELATED APPLICATIONS

The present application claims priority from U.S. Provisional Patent Application Ser. No. 63/371,823 filed on Aug. 18, 2022, the content of which is incorporated by reference in its entirety.

### FIELD

The present technology relates to machine learning and mixed reality (MR) in general, and more specifically to methods and systems for contextualizing and selecting objects for placement in mixed reality environments.

### BACKGROUND

Mixed reality (MR) is a technology that is increasingly evolving and used in various situations, such as for educational purposes, tourism purposes, military purposes, medical purposes, advertising purposes, entertainment purposes including social media and much more. One can think of MR as being a tool developed for enhancing our visual perception of our surroundings. MR can be defined as a system that incorporates both virtual reality (VR) and augmented reality (AR) technologies to create an immersive and interactive experience that seamlessly merges digital content with the real world. The overlaid sensory information can be dynamic and contextually relevant to the user environment and actions.

Placement space detection is crucial in MR, as it allows software to interact with the images of the real-world perceived by the user. Without placement space detection, added objects would lack size and light reference, thus making it impossible for software to add the objects in the user vision so that it naturally blends with the environment.

While different techniques for detecting placement spaces and displaying digital information exist, there is a need for methods and systems for performing contextualized object selection for display in location and time-aware environments, including Mixed Reality (MR), mobile applications, Digital Out-of-Home (DOOH), and other related platforms.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

One or more embodiments of the present technology have been developed based on developers' appreciation that there is a need for MR software to efficiently adapt to a given situation and provide relevant objects for display without human intervention. Such situations may arise in various fields, such as in entertainment, education, manufacturing, and advertising, for example.

More specifically, developers have appreciated that by using machine learning models having been specifically trained to select objects for display based on location and contextual information, the relevance of the objects displayed to the user given a context may improve user experience, as well as save computational resources.

Thus, one or more embodiments of the present technology are directed to methods of and systems for contextualizing and selecting objects for placement in mixed reality environments. Moreover, the versatility of one or more embodiments of the present technology allows for potential extension beyond MR applications to other domains, including Digital Out-of-Home (DOOH) advertising displays, mobile applications, and various location and time aware platforms.

In accordance with a broad aspect of the present technology, there is provided a method for training a machine learning (ML) model for performing contextual object matching to display objects in real-time in a digital environment, the method being executed by at least one processing device. The method comprises: receiving at least one location corresponding to a potential location of a given user, receiving, for the at least one location, respective contextual information associated with a physical environment at the at least one location, receiving a plurality of objects to be displayed, each object of the plurality of objects being associated with respective object features, receiving an indication of a set of selected objects having been selected from the plurality of objects for display at the at least one location, and training the ML model to select objects from the plurality of objects based on at least the respective object features and the respective contextual information by using the set of selected objects as a target to thereby obtain a trained ML model.

In one or more implementations of the method, the method may be used for selecting objects for display on a placement space in digital environments such as mixed reality (MR), mobile applications and digital out-of-home (DOOH) interfaces.

In one or more implementations of the method, the method further comprises, prior to said receiving the indication of the set of objects having been selected from the plurality of objects for display at the given location: transmitting, to at least one client device connected to the at least one processing device, the plurality of objects, the at least one location and the respective contextual information for annotation by a user associated with the client device.

In one or more implementations of the method, the method further comprises, prior to said receiving the indication of the set of objects having been selected from the plurality of objects for display at the given location: receiving, for the at least one location, at least one candidate placement space for displaying objects thereon, the at least one candidate placement space being associated with respective placement space features, and transmitting, to the client device, at least one candidate placement space for consideration when selecting the set of objects.

In one or more implementations of the method, said training of the ML model is further based on the candidate features of at least one candidate placement space.

In one or more implementations of the method, the respective object features comprise at least one of: a respective title of the object, a respective description of the object, and a respective category of the object.

In one or more implementations of the method, the respective object features comprise at least one of: a respective size of the object and a respective color of the object.

In one or more implementations of the method, the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location.

In one or more implementations of the method, the contextual information is associated with contextual features comprising a category of the contextual information, said training of the ML model is further based on the contextual features.

In one or more implementations of the method, said training of the ML model is performed using a hybrid model combining collaborative filtering and contextual objects similarity embedding techniques.

In accordance with a broad aspect of the present technology, there is provided a method for selecting objects for display on a placement space in a mixed reality (MR) environment in real-time, the method being executed by at least one processing device. The method comprises: receiving a location and an indication of a physical environment of a user, receiving, based on at least the location and the indication of the physical environment, a set of candidate placement spaces for display of objects, the set of candidate placement spaces corresponding to physical placement spaces in the physical environment of the user, receiving, based on the location, contextual information of the physical environment of the user at the location, receiving a plurality of objects, each respective object being associated with respective object features, determining, using a trained machine learning (ML) model, based on the location, the contextual information, and the respective objects features, a set of relevant objects to be displayed on the set of candidate placement spaces, and transmitting an indication of the set of relevant objects for the set of candidate placement spaces, thereby causing display of at least one relevant object on a given candidate placement space.

In one or more implementations, the method may be performed for selecting objects for display on a placement space in other types of digital environments, such as mobile applications and digital out-of-home (DOOH) interfaces.

In one or more implementations of the method, the respective object features comprise at least one of: a respective title of the respective object, a respective description of the respective object, and a respective category of the respective object.

In one or more implementations of the method, the respective object features comprise at least one of: a respective size of the respective object and a respective color of the respective object.

In one or more implementations of the method, the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location.

In one or more implementations of the method, the contextual information is associated with contextual features comprising a category of the contextual information, said determining, using the trained machine learning (ML) model, based on the location, the contextual information, and the respective objects features, the set of relevant objects to be displayed on the set of candidate placement spaces is further based on the contextual features.

In one or more implementations, the method may be stored in the form of computer-readable instructions in a non-transitory storage medium.

In accordance with a broad aspect of the present technology, there is provided a system for training a machine learning (ML) model for performing contextual object matching to display objects in real-time in a digital environment. The system comprises: at least one processing device, and a non-transitory storage medium operatively connected to the at least processing device, the non-transitory storage medium storing computer-readable instructions thereon. The at least one processing device, upon executing the computer-readable instructions, is configured for: receiving at least one location corresponding to a potential location of a given user, receiving, for the at least one location, respective contextual information associated with a physical environment at the at least one location, receiving a plurality of objects to be displayed, each object of the plurality of objects being associated with respective object features, receiving an indication of a set of selected objects having been selected from the plurality of objects for display at the at least one location, and training the ML model to select objects from the plurality of objects based on at least the respective object features and the respective contextual information by using the set of selected objects as a target to thereby obtain a trained ML model. In one or more implementations of the system, the system is further configured for, prior to said receiving the indication of the set of objects having been selected from the plurality of objects for display at the given location: transmitting, to at least one client device connected to the at least one processing device, the plurality of objects, the at least one location and the respective contextual information for annotation by a user associated with the client device.

In one or more implementations of the system, the system may be used for selecting objects for display on a placement space in a digital environment, such as mixed reality (MR), mobile applications and digital out-of-home (DOOH) interfaces.

In one or more implementations of the system, the system is further configured for, prior to said receiving the indication of the set of objects having been selected from the plurality of objects for display at the given location: receiving, for the at least one location, at least one candidate placement space for displaying objects thereon, the at least one candidate placement space being associated with respective placement space features, and transmitting, to the client device, at least one candidate placement space for consideration when selecting the set of objects.

In one or more implementations of the system, said training of the ML model is further based on the candidate features of at least one candidate placement space.

In one or more implementations of the system, the respective object features comprise at least one of: a respective title of the object, a respective description of the object, and a respective category of the object.

In one or more implementations of the system, the respective object features comprise at least one of: a respective size of the object and a respective color of the object.

In one or more implementations of the system, the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location.

In one or more implementations of the system, the contextual information is associated with contextual features comprising a category of the contextual information, said training of the ML model is further based on the contextual features.

In one or more implementations of the system, said training of the ML model is performed using a hybrid model combining collaborative filtering and contextual objects similarity embedding techniques.

In accordance with a broad aspect of the present technology, there is provided a system for selecting objects for display on a placement space in a mixed reality (MR) environment in real-time, the system comprising: at least one processing device, and a non-transitory storage medium operatively connected to the at least processing device, the non-transitory storage medium storing computer-readable instructions thereon. The at least one processing device, upon executing the computer-readable instructions, is configured for: receiving a location and an indication of a physical environment of a user, receiving, based on at least the location and the indication of the physical environment, a set of candidate placement spaces for display of objects, the candidate placement space corresponding to physical placement spaces in the physical environment of the user, receiving, based on the location, contextual information of the physical environment of the user at the location, receiving a plurality of objects, each respective object being associated with respective object features, determining, using a trained machine learning (ML) model, based on the location, the contextual information, and the respective objects features, a set of relevant objects to be displayed on the set of candidate placement spaces, and transmitting an indication of the set of relevant objects for the set of candidate placement spaces, thereby causing display of at least one relevant object on a given candidate placement space.

In one or more implementations of the system, the system may be used for selecting objects for display on a placement space in digital environments such as mobile applications and digital out-of-home (DOOH) interfaces.

In one or more implementations of the system, the respective object features comprise at least one of: a respective title of the respective object, a respective description of the respective object, and a respective category of the respective object.

In one or more implementations of the system, the respective object features comprise at least one of: a respective size of the respective object and a respective color of the respective object.

In one or more implementations of the system, the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location.

In one or more implementations of the system, the contextual information is associated with contextual features comprising a category of the contextual information, said determining, using the trained machine learning (ML) model, based on the location, the contextual information, and the respective objects features, the set of relevant objects to be displayed on the candidate placement space is further based on the contextual features.

In one or more implementations of the system, the trained ML model comprises a hybrid model combining collaborative filtering and contextual objects similarity embedding techniques.

### Terms and Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device”, which may also be referred to as “computing device”, is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, a “wearable device”, refers to an electronic device with the capability to present visual data (e.g., text, images, videos, etc.) and optionally audio data (e.g., music) that is configured to be worn by a user and/or mountable (e.g., fixed) on the user of the wearable device (e.g., sometimes under or over clothing; and/or sometimes integrated with and/or as clothing and/or another accessory, such as, for example, a hat, eyeglasses, a wrist watch, shoes, etc.). A wearable device can comprise an electronic device or be connected to an electronic device. In some non-limiting examples, a wearable user computer device can comprise a head mountable wearable user computer device (e.g., one or more head mountable displays, one or more eyeglasses, one or more contact lenses, one or more retinal displays, etc.) or a limb mountable wearable user computer device. In these examples, a head mountable wearable user computer device can be mountable in close proximity to one or both eyes of a user of the head mountable wearable user computer device and/or vectored in alignment with a field of view of the user.

Non-limiting examples of head mountable wearable devices may comprise a Google Glass™ product or a similar product by Google Inc. of Menlo Park, Calif., United States of America; the Eye Tap™ product, the Laser Eye Tap™ product, or a similar product by ePI Lab of Toronto, Ontario, Canada, and/or the Raptyr™ product, the STAR 1200™ product, the Vuzix Smart Glasses M100™ product, or a similar product by Vuzix Corporation of Rochester, N.Y., United States of America. In other non-limiting examples, a head mountable wearable user computer device can comprise the Virtual Retinal Display™ product, or similar product by the University of Washington of Seattle, Wash., United States of America.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented, or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e., its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the expression “object” refers to any digital element that can be integrated within a placement space to be displayed on a display interface. Objects can take various forms, including but not limited to images, videos, 3D models, etc.

In the context of the present specification, “mixed reality”, also referred to as “hybrid reality”, refers to computer-based techniques that combine computer generated sensory information (e.g., images, objects, text) with a real-world environment (e.g., images or video of a table, room, wall, or other space). A mixed reality environment can be generated by superimposing (i.e., overlaying) a virtual image on a user's view of the real-world image and displaying the superimposed image. A mixed reality environment can be displayed as a single image, plurality of images, a video and can be displayed live and/or continuously (e.g., video stream).

In the context of the present specification, the term “placement space” refers to the specific areas within an application interface that are designated for displaying various types of objects, such as banners, interstitials, or natives. In the case of Mixed Reality (MR), “placement space” can also be used to describe the virtual areas or surfaces where digital objects are integrated into the user's MR experience.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a schematic diagram of an electronic device in accordance with one or more non-limiting embodiments of the present technology.

FIG. 2 illustrates a schematic diagram of a communication system in accordance with one or more non-limiting embodiments of the present technology.

FIG. 3 illustrates a schematic diagram of a contextualized object mixed reality (MR) placement procedure in accordance with one or more non-limiting embodiments of the present technology.

FIG. 4 illustrates a schematic diagram of an example of real-time contextualized object placement using the contextualized object MR placement procedure of FIG. 3 in accordance with one or more non-limiting embodiments of the present technology.

FIG. 5 illustrates a schematic diagram of a data annotation and training procedure in accordance with one or more non-limiting embodiments of the present technology.

FIG. 6 illustrates a flow chart of a method of training a machine learning (ML) model for performing contextual object selection for displaying objects on a placement space in a mixed reality (MR) environment in accordance with one or more non-limiting embodiments of the present technology.

FIG. 7 illustrates a flow chart of a method of selecting objects for display on a placement space in a mixed reality (MR) environment in real-time in accordance with one or more non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a central processing unit (CPU), or a processor dedicated to a specific purpose, such as a graphics processing unit (GPU). Moreover, explicit use of the term “processing device”, “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

Electronic Device

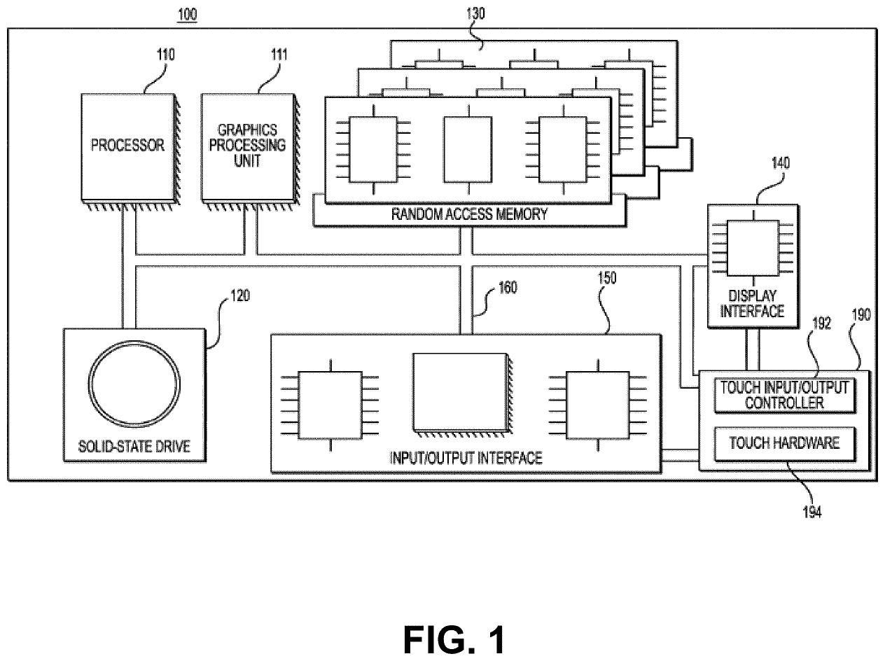

Referring to FIG. 1, there is shown an electronic device 100 suitable for use with some implementations of the present technology, the electronic device 100 comprising various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the electronic device 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more embodiments, the input/output interface 150 may be connected to a keyboard (not shown), a mouse (not shown) or a trackpad (not shown) allowing the user to interact with the electronic device 100 in addition or in replacement of the touchscreen 190.

According to implementations of the present technology, the solid-state drive 120 stores program instructions suitable for being loaded into the random-access memory 130 and executed by the processor 110 and/or the GPU 111 for performing contextualized object AR placement. For example, the program instructions may be part of a library or an application.

The electronic device 100 may be implemented as a server, a desktop computer, a laptop computer, a tablet, a smartphone, a personal digital assistant, or any device that may be configured to implement the present technology, as it may be understood by a person skilled in the art.

System

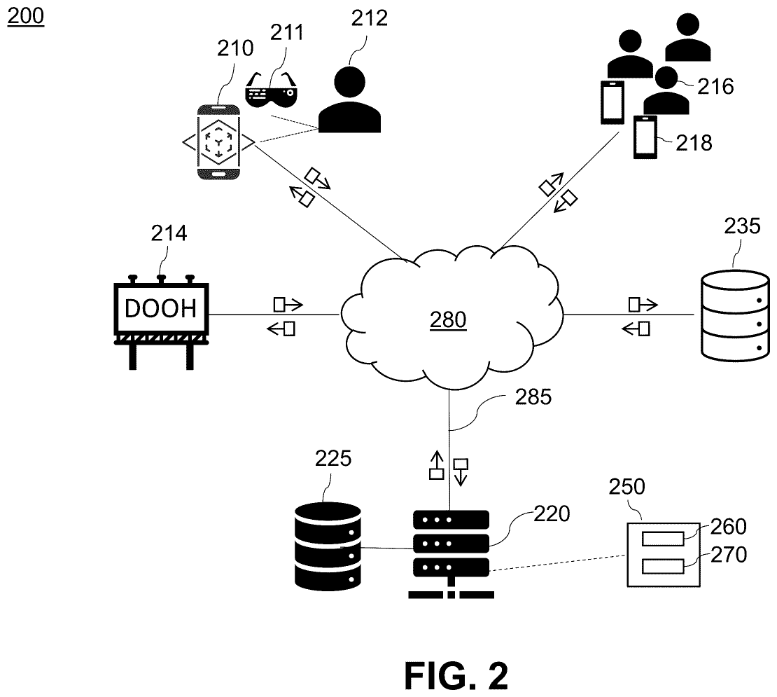

Referring to FIG. 2, there is shown a schematic diagram of a communication system 200, which will be referred to as system 200, the system 200 being suitable for implementing one or more non-limiting embodiments of the present technology. It is to be expressly understood that the system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The system 200 comprises inter alia a client device 210, 211 associated with a user 212, an optional digital out-of-home (DOOH) interface 214, a server 220 associated with a first database 225, and a second database 235 communicatively coupled over a communications network 280.

The system 200 further comprises, in some embodiments, coupled to communication network 280, client devices 218 (only one numbered) associated with respective users 216 (only one numbered). The respective users 216 and client devices 218 may be collectively referred to as assessors.

Client Device

The system 200 comprises client devices 210, 211. The client devices 210, 211 are associated with the user 212. As such, a given one of the client devices 210, 211 can sometimes be referred to as a “electronic device”, “computing device” “end user device”, “wearable user device” or “client electronic device”. It should be noted that the fact that the client devices 210, 211 are associated with the user 212 does not need to suggest or imply any mode of operation such as a need to log in, a need to be registered, or the like. As shown in FIG. 2, client device 210 is implemented as a smartphone linked to client device 211 implemented as MR wearable glasses. It should be understood that while two linked client devices 210, 211 are shown for illustrative purposes, the user 212 may only use or have one of the client devices 210, 211.

While only two client devices 210, 211 and one user 212 are illustrated in FIG. 2, it should be understood that the number of client devices and users is not limited, and may include dozens, hundreds or thousands of client devices and users.

Each of the client devices 210, 211 comprises one or more components of the electronic device 100 such as one or more single or multi-core processors collectively represented by processor 110, the graphics processing unit (GPU) 111, the solid-state drive 120, the random-access memory 130, the display interface 140, and the input/output interface 150.

At least one of the client devices 210, 211 is equipped with one or more imaging sensors for capturing images and/or videos of its physical surroundings, which will be used for generating augmented AR or MR views of the real-world environment acquired by the imaging sensors, and which will be displayed on a display interface of at least one the client devices 210, 211 or another electronic device. The one or more imaging sensors may include cameras with CMOS or CCD imaging sensors.

In the context of the present technology, at least one of the client devices 210, 211 is used to display objects on physical placement spaces in an augmented reality environment on a display interface of the client device 210, 211 to the user 212, the objects having been selected for display by using the procedures that will be explained in more detail herein below.

In the context of the present technology, at least one of the client devices 210, 211 is a VR, AR, or MR-enabled device configured to integrate and display digital information in real time in a real-word environment captured by the imaging sensors of at least one of the client devices 210, 211. In one or more embodiments, the client device 210, 211 may be implemented as a single wearable user device.

As a non-limiting example, at least one of the client devices 210, 211 may be implemented as a smartphone, tablet, AR glasses, or may be integrated into a heads-up display (HUD) of a vehicle windshield, helmet, or other type of headset.

The client devices 218 associated with the respective users 216 may each be implemented similarly to the client device 210. Each client device 218 may be a different type of device, and some of the client devices may not be necessarily equipped with imaging sensors. The respective users 216 are tasked with providing training data by labelling objects, which will be used for training one or more machine learning models as will be described below.

In some embodiments, the system 200 comprises the DOOH interface 214 connected to the communication network 280 via a respective communication link (not separately numbered). The DOOH interface 214 comprises a display interface such as a LED, LCD or OLED for display of visual content, the display interface being connected to a media player or computing device for content processing. The DOOH interface 214 may execute or may be connected to a Content Management System (CMS) to enable remote control of displayed content.

The DOOH interface 214 may include a mounting system to support the physical structure and a power supply to provide power for continuous operation. Non-limiting examples of DOOH interfaces includes digital billboards along highways, interactive kiosks in shopping malls, electronic menu boards in restaurants, real-time transit information displays at bus or train stations, and advertising screens in airport terminals.

Server

The server 220 is configured to inter alia: (i) receive a location and images of an environment of a user 212 captured by the client device 210; (ii) receive, based on the images, a set of potential physical placement spaces on which objects may be displayed; (iii) receive contextual information and a plurality of objects; (iv) select relevant objects for display on the potential placement spaces based on at least contextual information and object features; and (v) generate an augmented view comprising at least one object to be displayed on a given placement space in a MR environment in real-time

How the server 220 is configured to do so will be explained in more detail herein below.

It will be appreciated that the server 220 can be implemented as a conventional computer server and may comprise at least some of the features of the electronic device 100 shown in FIG. 1. In a non-limiting example of one or more embodiments of the present technology, the server 220 is implemented as a server running an operating system (OS). Needless to say that the server 220 may be implemented in any suitable hardware and/or software and/or firmware or a combination thereof. In the disclosed non-limiting embodiment of present technology, the server 220 is a single server. In one or more alternative non-limiting embodiments of the present technology, the functionality of the server 220 may be distributed and may be implemented via multiple servers (not shown).

The implementation of the server 220 is well known to the person skilled in the art. However, the server 220 comprises a communication interface (not shown) configured to communicate with various entities (such as the first database 225, for example and other devices potentially coupled to the communication network 280) via the communication network 280. The server 220 further comprises at least one computer processor (e.g., the processor 110 and/or GPU 111 of the electronic device 100) operationally connected with the communication interface and structured and configured to execute various processes to be described herein.

The server 220 has access to a set of machine learning (ML) models 250.

Machine Learning (ML) Models

The set of ML models 250 comprise inter alia one or more matching ML models 260, and one or more image processing ML models 270.

In the context of the present technology, the matching ML models 260 are configured to match one or more of object features, location features, contextual features, and optionally placement space features to select relevant objects for display.

The matching ML models 260 are trained on training datasets where relevant objects are labelled and provided as a target to the matching model 260, which may take into account one or more of the location features, contextual features, and optionally placement space features to learn how to select relevant objects for display. It will be appreciated that a plurality of matching ML models may be trained using different features, and their performances may be compared to select at least one trained matching model 260 for use.

In one or more embodiments, the matching ML models 260 may be implemented and trained using a hybrid model combining collaborative filtering and contextual objects similarity embedding techniques.

Collaborative filtering is a type of machine learning technique used in recommendation systems to make predictions or suggestions about items. In some embodiments of the present technology, collaborative filtering can be used to automate the process of objects selection preferences based on the historical number of views of the objects, while taking into consideration the location and contextual information. The underlying idea is that objects that have previously gained the attention of viewers in the past with respect to their location and other contextual factors will have a higher likelihood of being viewed. More details about collaborative filtering are provided in paper by Koren, Yehuda, Steffen Rendle, and Robert Bell. “Advances in collaborative filtering.” Recommender systems handbook (2021): 91-142.

Contextual object similarity embedding refers to a technique used in machine learning that represents input data in a continuous vector space based on their similarities. The goal is to map contextual features and objects into a high-dimensional vector space, where contextual features and objects paired with similar intent are located closer to each other in the embedding space.

In one or more embodiments, the matching ML models 260 may be implemented as Matching Networks. In such embodiments, the matching ML model 260 learns different embedding functions for training samples and test samples.

In one or more alternative embodiments, the matching ML models 260 may be implemented based on a combination of collaborative filtering and contextual objects similarity embedding techniques.

Image Processing Models

The image processing models 270 are configured to perform one or more of image classification, object localization, object detection, and object segmentation in images.

In the context of the present technology, the image processing models 270 are used to detect placement spaces in images where objects may be overlaid. Additionally, the image processing models 270 may be configured to scale and modify the objects such that the objects appear as if they were physically present on the placement spaces.

Non-limiting of image processing models 270 includes Regions with Convolutional neural networks (R-CNN), Fast R-CNN, and Faster-RCNN and You Only Look Once (YOLO)-based models.

In one or more embodiments, the set of ML models 250 may further comprise inter alia a set of classification ML models (not illustrated). Additionally, or alternatively, the set of ML models 250 may further comprises a set of regression ML models (not shown).

It will be appreciated that depending on the type of prediction task to be performed, i.e., classification or regression, the set of ML models 250 may comprise the set of classification ML models, the set of regression ML models, or a combination thereof.

Classification ML models are models that attempt to estimate the mapping function (f) from the input variables (x) to one or more discrete or categorical output variables (y). The set of classification MLAs may include linear and/or non-linear classification MLAs.

Non-limiting examples of classification ML models include: Perceptrons, Naive Bayes, Decision Tree, Logistic Regression, K-Nearest Neighbors, Artificial Neural Networks (ANN)/Deep Learning (DL), Support Vector Machines (SVM), and ensemble methods such as Random Forest, Bagging, AdaBoost, and the like.

Regression ML models attempt to estimate the mapping function (f) from the input variables (x) to numerical or continuous output variables (y).

Non-limiting examples of regression ML models include: Linear Regression, Ordinary Least Squares Regression (OLSR), Stepwise Regression, Multivariate Adaptive Regression Splines (MARS), Locally Estimated Scatterplot Smoothing (LOESS), and Logistic Regression.

In one or more embodiments, the set of ML models 250 may have been previously initialized, and the server 220 may obtain the set of ML models 250 from the first database 225, or from an electronic device connected to the communication network 280.

In one or more other embodiments, the server 220 obtains the set of ML models 250 by performing a model initialization procedure to initialize the model parameters and model hyperparameters of the set of ML models 250.

The model parameters are configuration variables of a machine learning model which are estimated or learned from training data, i.e., the coefficients are chosen during learning based on an optimization strategy for outputting a prediction according to a prediction task.

In one or more embodiments, the server 220 obtains the hyperparameters in addition to the model parameters for the set of ML models 250. The hyperparameters are configuration variables which determine the structure.

In one or more embodiments, training of the set of ML models 250 is repeated until a termination condition is reached or satisfied. As a non-limiting example, the training may stop upon reaching one or more of: a desired accuracy, a computing budget, a maximum training duration, a lack of improvement in performance, a system failure, and the like.

In one or more embodiments, the server 220 may execute one or more of the set of ML models 250. In one or more alternative embodiments, one or more of the set of ML models 250 may be executed by another server (not depicted), and the server 220 may access the one or more of the set of ML models 250 for training or for use by connecting to the server (not shown) via an API (not depicted), and specify parameters of the one or more of the set of ML models 250, transmit data to and/or receive data from the ML models 250, without directly executing the one or more of the set of ML models 250.

As a non-limiting example, one or more of the set of ML models 250 may be hosted on a cloud service providing a machine learning API.

First Database

A first database 225 is communicatively coupled to the server 220 and the client device 210, 211 via the communications network 280 but, in one or more alternative implementations, the first database 225 may be directly coupled to the server 220 without departing from the teachings of the present technology. Although the first database 225 is illustrated schematically herein as a single entity, it will be appreciated that the first database 225 may be configured in a distributed manner, for example, the first database 225 may have different components, each component being configured for a particular kind of retrieval therefrom or storage therein.

The first database 225 may be a structured collection of data, irrespective of its particular structure or the computer hardware on which data is stored, implemented or otherwise rendered available for use. The first database 225 may reside on the same hardware as a process that stores or makes use of the information stored in the first database 225 or it may reside on separate hardware, such as on the server 220. The first database 225 may receive data from the server 220 for storage thereof and may provide stored data to the server 220 for use thereof.

In one or more embodiments, the first database 225 may store ML file formats, such as .tfrecords, .csv, .npy, and .petastorm as well as the file formats used to store models, such as .pb and .pkl. The first database 225 may also store well-known file formats such as, but not limited to image file formats (e.g., .png, .jpeg), video file formats (e.g., .mp4, .mkv, etc), archive file formats (e.g., .zip, .gz, .tar, .bzip2), document file formats (e.g., .docx, .pdf, .txt) or web file formats (e.g., .html).

In one or more embodiments of the present technology, the first database 225 is configured to store inter alia: (i) location data; (ii) images and/or videos and associated features; (iii) contextual information about locations and users; (iv) objects and associated features; (v) annotated objects; and (vi) model parameters and hyperparameters of the set of ML models 250.

Second Database

The second database 235 refers to a collection of databases communicatively coupled to the communication network 280. The second database 235 may be implemented in a manner similar to the first database 225.

In one or more embodiments, each database may store respective information accessible by the server 220 and/or the client device 210. In such embodiments, a given database may store contextual information about locations, while another given database may store a plurality of objects that may be retrieved for display in an MR environment. For example, the second database 235 may include an object source (not shown in FIG. 2) and support information sources (not shown in FIG. 2).

Communication Network

In one or more embodiments of the present technology, the communication network 280 is the Internet. In one or more alternative non-limiting embodiments, the communication network 280 may be implemented as any suitable local area network (LAN), wide area network (WAN), a private communication network or the like. It will be appreciated that implementations for the communication network 280 are for illustration purposes only. How a communication link 285 (not separately numbered) between the client device 210, the server 220, the first database 225, the second database 235 and/or another electronic device (not shown) and the communication network 280 is implemented will depend inter alia on how each electronic device is implemented.

The communication network 280 may be used in order to transmit data packets amongst the client device 210, the server 220, the first database 225 and the second database 235. For example, the communication network 280 may be used to transmit requests from the client device 210, 211 to the server 220. In another example, the communication network 280 may be used to transmit data from the first database 225 and the second database 235 to the server 220.

Having described non-limiting examples of how the communication system 200 is implemented, a contextualized object placement procedure 300 will now be described in more detail.

Contextualized Object Placement Procedure

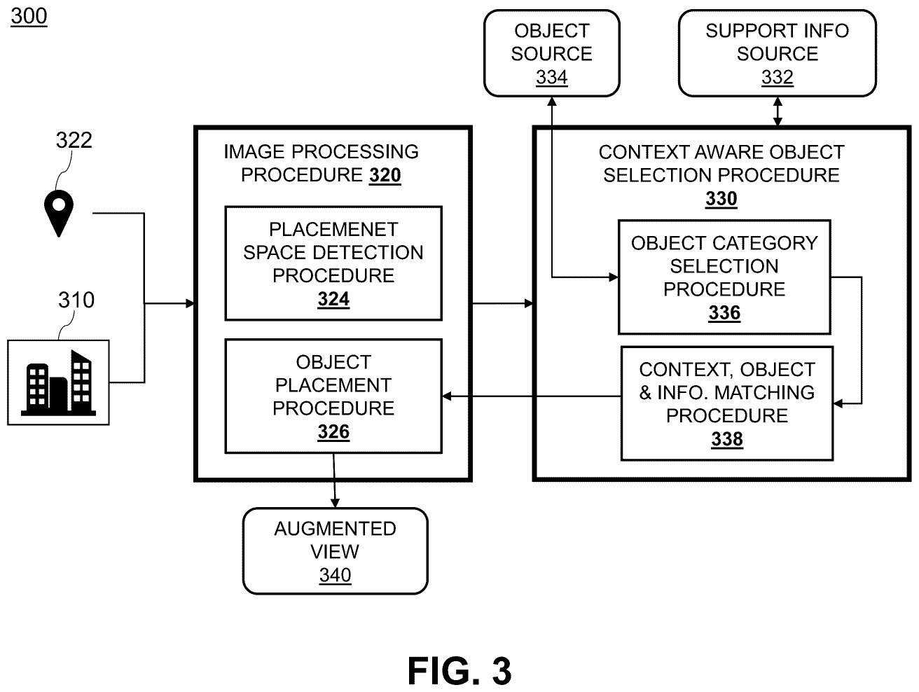

With reference to FIG. 3, there is shown a schematic diagram of a contextualized object placement procedure 300 in a MR environment in accordance with one or more non-limiting embodiments of the present technology.

In one or more embodiments of the present technology, the server 220 executes the contextualized MR object placement procedure 300. In alternative embodiments, the server 220 may execute at least a portion of the contextualized MR object placement procedure 300, and one or more other servers (not shown) may execute other portions of the contextualized MR object placement procedure 300. It will be appreciated that that any computing device having the required processing capabilities may execute the contextualized MR object placement procedure 300. For example, in alternative embodiments, the client device 210, 211 may execute the contextualized MR object placement procedure 300.

The contextualized MR object placement procedure 300 is configured to generate an augmented view 340 comprising at least one object displayed on a placement space in an MR environment in real-time based on a location 322 and images 310 of an environment of a user 212 captured by the client device 210. The augmented view 340 may then be transmitted for display to the user 212 on the client device 210.

To achieve that purpose, the contextualized MR object placement procedure 300 comprises inter alia an image processing procedure 320 and a context-aware object selection procedure 330. It will be appreciated that the image processing procedure 320 and the context-aware object selection procedure 330 are executed by at least one processing device, which may be two or more different processing devices (e.g., server 220 and client device 210, 211 or other server), or may be a single processing device (e.g., the server 220).

The image processing procedure 320 and the context-aware object selection procedure 330 collaborate to generate the augmented view 340 comprising at least one object displayed in an MR environment in real-time based on a location 322 and images 310 of a physical environment of a user 212 captured by the client device 210.

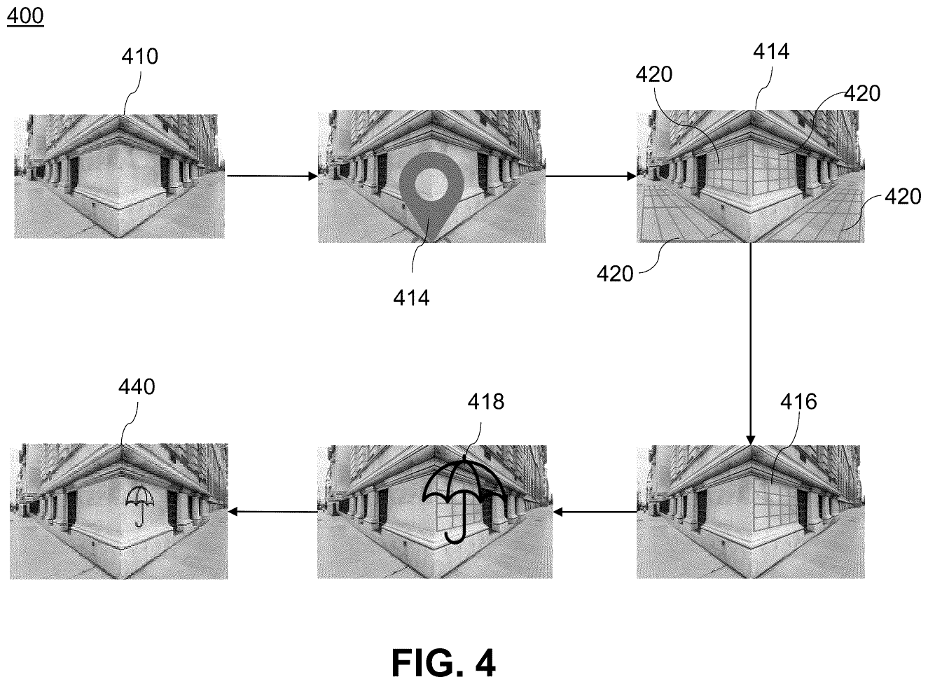

With brief reference to FIG. 4, there is illustrated a non-limiting example of inputs and outputs of the image processing procedure 320 and the context-aware object selection procedure 330 of the contextualized MR object placement procedure 300 of FIG. 3.

An image 410 of a corner of a building is acquired by a camera of the client device 210, 211 and received by the image processing procedure 320. A current location 414 of the client device 210 is acquired by the client device 210, 211 and received by the context-aware object selection procedure 330.

The image 410 is processed by the image processing procedure 320 to detect a set of potential placement spaces 420 (not separately numbered). The set of potential placement spaces 420 include walls of the building and sidewalks. In some embodiments, the set of potential placement space 420 may be optionally provided to the context-aware object selection procedure 330.

The context-aware object selection procedure 330 uses the current location 414 to obtain contextual information about the physical environment.

The context-aware object selection procedure 330 has access to a plurality of objects.

The context-aware object selection procedure 330 matches object features, contextual information, and the current location to obtain relevant objects for display on the set of potential placement spaces 420 (not illustrated).

The context-aware object selection procedure 330 and/or the image processing procedure 320 select a given placement space 416 of the set of potential placement spaces 420 on which to display a relevant object 418. In the example shown in FIG. 4, the relevant object 418 corresponds to a depiction of an umbrella.

The image processing procedure 320 generates an augmented view 440 comprising the relevant object 418 overlaid on the selected placement space 416, where the shape, position and lighting of the object are adapted to the selected placement space 416 such that the object 418 appears as if it was a physical depiction of an umbrella displayed on the wall.

The augmented view 440 is transmitted for display on a display interface of at least one of the client devices 210, 211 such that it can be visible to the user 212.

How the relevant object 418 has been selected to be displayed on the selected placement space 416 by the contextualized MR object placement procedure 300 will now be described.

Turning back to FIG. 3, the contextualized MR object placement procedure 300 will be described for at least one of the client devices 210, 211 associated with the user 212 located at a given location 322. It will be appreciated that the contextualized MR object placement procedure 300 may be executed for a plurality of client devices simultaneously.

Image Processing Procedure

The image processing procedure 320 comprises a placement space detection procedure 324 and an object placement procedure 326.

The image processing procedure 320 is configured to inter alia: (i) receive one or more images 310 of a physical environment of the user 212 acquired by the client device 210; (ii) receive a location 322 of the client device 210; (iii) perform, based on the images 310, a placement space detection procedure 324 to output a set of potential placement spaces for displaying objects; (iv) optionally transmit the set of potential placement spaces to the context-aware object selection procedure 330; (v) receive relevant objects from the context-aware object selection procedure 330 for the set of potential placement spaces; and (vi) generate the augmented view 340 comprising at least one relevant object.

The augmented view 340 may then be transmitted for display to the client device 210, 211 such that a current environment in the field of view of the camera sensor(s) of the client device 210, 211 and the user 212 is displayed with the relevant object overlaid on a given placement space.

The image processing procedure 320 receives one or more images 310 of the physical environment of the user 212 acquired by the client device 210.

It will be appreciated that the images 310 may be one or more static images, or may be in the form of a video, such as a live video stream of a physical environment of the user 212 captured by one or more cameras of the client device 210. It will be appreciated that the type, size, resolution, and format of the images 310 depends on the processing capabilities of the client device 210, 211 and the server 220 implementing the present technology.

The physical environment of the user 212 may include portions of structures, people, animals, vehicles, roads, objects, and the like. As a non-limiting example, the user 212 may be located in a city, within a building, in nature, etc.

The image processing procedure 320 receives the location 322 of the user 212.

In some embodiments, the location 322 is obtained using the Global Positioning System (GPS), which provides a geolocation and time information to a GPS receiver anywhere on the planet using global navigation satellite systems (GNSS). It will be understood that the GPS receiver is comprised in the client device 210, or in another electronic device in communication with and in proximity of the client device 210. The location 322 is usually in the form of a set of longitudinal and latitudinal coordinates, but may be of any form suitable to identify the geolocation of the client device 210.

In one or more alternative embodiments, the location 322 is obtained using image recognition algorithms that analyze features in the image 310 and associate the analyzed features with known locations. The analysis and association may be performed by the client devices 210, 211, the server 220 or another device (not shown), and the information about the known locations may be stored in the random-access memory 130, the first database 225 and/or the second database 235.

In some embodiments, the location 322 is obtained using sensors suitable to track the displacement of at least one of the client devices 210, 211 from a previous known location. For instance, the location 322 may be recorded for a given moment using the GPS or image recognition algorithms, and a subsequent location may be obtained by calculating the displacements that occurred between the obtaining of the location 322 and the subsequent location. In this embodiment, the sensors may be accelerometers and gyroscopes configured to measure the amplitude and orientation of acceleration vectors and may be mounted and connected to at least one of the client devices 210, 211.

The image processing procedure 320 determines, based on the images 310, using the placement space detection procedure 324, a set of potential physical placement spaces for display.

The physical placement spaces may include static placement spaces and/or dynamic placement spaces. Non-limiting examples of physical placement spaces include walls, floors, ceilings, furniture, windows, panels, vehicles, or any type of structure and/or object having a sufficiently dimensioned display placement space. Dynamic placement spaces may for example include water or a moving vehicle.

The placement space detection procedure 324 may have access to the set of ML models 250 including image processing models 270 for performing recognition and/or segmentation of placement spaces detected in images. For example, the image processing procedure 320 may use computer vision (CV) techniques for performing recognition of physical placement spaces. Detection of features may be performed using feature detection techniques including corner detection, blob detection, edge detection or thresholding, and other image processing methods.

In one or more embodiments, the placement spaces are associated with respective placement space features (not illustrated). The respective placement space feature may include image features (e.g., metadata) of the placement space, such as, but not limited to, size, color, opacity, visibility, type of object/structure of the placement space, material of the placement space, and owner of the placement space. Further the candidate placement space features may include image features, including deep features extracted by a feature extraction ML model (not illustrated), also referred to as a feature extractor. The feature extractor may be based on convolutional neural networks (CNNs) and include, as a non-limiting example, models such as ResNet, ImageNet, GoogleNet and AlexNet.

The placement space detection procedure 324 will not be described in more detail herein.

The image processing procedure 320 is configured to receive at least one relevant object from the context-aware object selection procedure 330 and an indication of a placement space on which to display the relevant object. How the context-aware objection selection procedure 330 provides the relevant object will be described in more detail herein below.

The image processing procedure 320 performs an object placement procedure 326 to generate an augmented view 340 comprising at least one relevant object displayed on the placement space. It will be appreciated that the augmented view 340 may be generated based on a current FOV of the user 212 (for example if the user is currently in movement) and displayed such that the relevant object scales and is oriented naturally with the placement space as seen by the user 212.

The object placement procedure 326 may use different techniques for positioning and displaying objects on placement spaces. Once the placement spaces of the physical environment are modeled, the dimensions of the object are adapted to suit the environment dimensions, and the object is projected on a given placement space. The object placement procedure 326 may match the light projection of the displayed object with the lighting and shading of the placement space onto which the object is projected. Additionally, the boundaries of the object may be adapted to match the shape of the placement space onto which the object is projected to ensure a natural blend of the object and the placement space.

The object placement procedure 326 will not be described in more detail herein.

The image processing procedure 320 transmits the augmented view 340 for display on a given one of the client devices 210, 211 of the user 212.

The image processing procedure 320 and the context-aware object selection procedure 330 are executed in parallel. It will be appreciated that the image processing procedure 320 and the context-aware object selection procedure 330 may be executed on different computing devices in communication with each other.

Context-Aware Object Selection Procedure

The context-aware object selection procedure 330 comprises inter alia an object category selection procedure 336 and a context object information matching procedure 338.

The context-aware object selection procedure 330 has access to one or more ML models of the set of ML models 250. In one or more embodiments, the context-aware object selection procedure 330 accesses one or more trained matching ML models 260 having been trained to perform object matching based on annotated examples, as will be explained below.

The context-aware object selection procedure 330 is configured to inter alia: (i) receive the location 322 and the potential placement space from the placement space detection procedure 324; (ii) receive, from an object source 334, a plurality of objects; (iii) select, using the object category selection procedure 336, based at least on the plurality of objects, a set of selected objects categories; (iii) receive, from one or more support information source 332, contextual information related to the location 322; (iv) perform, via the context object information matching procedure 338 using the trained matching ML model 260, matching of contextual information, candidate placement space and objects belonging to the top categories predicted by the object category selection procedure 336 to obtain a set of relevant objects; and (v) transmit the set of relevant objects to the image processing procedure 320.

The context-aware object selection procedure 330 has access to the object source 334 storing a plurality of objects, and one or more support information source 332 storing contextual information about locations. The object source 334 and the one or more support information sources 332 may for example be located within the first database 225 connected to the communication network 280 and accessible to the context-aware object selection procedure 330 for retrieval and storage of data.

The context-aware object selection procedure 330 receives from the object source 334, a plurality of objects. The plurality of objects may be stored in the first database 225 or a non-transitory storage medium of the server 220.

Object Source

The object source 334 stores a plurality of objects which may be used for display in a digital environment including MR such as on a display of one of the client devices 210, 211, on a mobile application, or DOOH contexts (e.g., on the DOOH interface 214 in the field of view of the user 212). In one or more embodiments, the object source 334 may be a plurality of objects sources. As a non-limiting example, each object source 334 may include objects from different object providers associated with an operator of the present technology.

The nature and number of objects present in the object source 334 and that may be displayed is not limited.

Objects may be static and/or dynamic and may include 2D objects and/or 3D objects. Non-limiting examples of objects include images, 3D models, animation effects, videos, which may be further associated with sounds, and other sensory data that may be sensed by the client device 210, 211 and provided as feedback to the user 212.

Each object of the plurality of objects has a respective set of object features. The set of object features include attributes of the object, which may be specified by the provider of the object(s), by other users(s) and/or may be added after an analysis thereof.

The set of object features may include features such as, but not limited to, a title of the object, a category of the object, type of object, color(s) of the object, size of the object, scale of the object, shape of the object, texture of the object, textual description of the object, a provider of the object, a product associated with the object, etc.

In some implementations, the set of object features may also specify which features of the object may be modified and which features of the objects may not be modified for display in an MR environment.

Additionally, the object features may include global and local image features, as well as deep features.

It will be appreciated that at least a portion of the object features may be extracted and/or acquired from other sources, and after the plurality of objects are received by the context-aware object selection procedure 330.

The context-aware object selection procedure 330 is configured to query one or more support information source 332 to receive contextual information related to the location.

Contextual Information

The one or more support information source 332 are configured to store contextual information about locations. In one or more embodiments, the one or more support information source 332 are located in the second database 235. In one or more alternative embodiments, the one or more support information source 332 may be each a separate information source accessible on the Internet via the communications network 280.

The contextual information is not limited and may include any type of information that is related to the physical location and the physical environment of the user 212 associated with the client device 210. The contextual information may include spatial information and temporal information related to the physical location(s).

In one or more embodiments, contextual information may be associated with contextual features. It will be appreciated that such features may vary depending on the type of contextual information.

The contextual information may include weather information, such as temperature, speed of wind, rain/snow conditions and the like, traffic information based on traffic reports or density, current special offers from vendors in proximity of the location, and events in proximity of the location.

The contextual information may include places in proximity of the location, such as a particular establishment or point of interest (POI). Each place may be associated with one or more of: identifier, type, atmosphere, geometry, textual description, and the like.

Object Category Selection

The context-aware object selection procedure 330 executes the object category selection procedure 336 to select a set of relevant categories of objects from the plurality of objects. The set of relevant categories may be a proper subset of the plurality of objects categories.

In one or more embodiments, the object category selection procedure 336 may select the relevant categories of objects based on respective contextual information about location and object features.

In one or more alternative embodiments, the object category selection procedure 336 may further select the relevant objects categories based on one or more of the location, and the contextual information of the location. It will be appreciated that the features of each of the one or more of the location, and the contextual information of the location may be considered by the object category selection procedure 336 in the selection of the set of objects.

The object category selection procedure 336 outputs the set of the most relevant objects categories.

The context-aware object selection procedure 330 is configured to execute a context object information matching procedure 338.

Context Object Information Matching Procedure

The context object information matching procedure 338 has access to trained matching ML model 260. The context object information matching procedure 338 uses the trained matching ML model 260 to match contextual information, placement space and objects belonging to the most relevant categories predicted by the object category selection procedure 336 to obtain a set of relevant objects for display on a given placement space. The set of relevant objects includes at least one relevant object.

How the trained matching ML model 260 has been trained to select the set of relevant objects will be described in more detail herein below.

In one or more embodiments, the trained matching ML model 260 selects a set of relevant objects from the set of objects based on the respective object features, the contextual information, the location, and the candidate placement space. It will be appreciated that the trained matching ML model 260 may take into account one or more of contextual information features (when available), candidate placement space features (when available).

In one or more embodiments, the trained matching ML model 260 outputs, for each object, a respective object relevance score. The respective object relevance score indicates how relevant an object is for display at the location 322 based on the contextual information as well as object features and placement space features.

In one or more embodiments, the context object information matching procedure 338 filters the objects based on the respective object relevance scores to obtain the set of relevant objects. As a non-limiting example, the context object information matching procedure 338 may only select objects to be included in the set of relevant objects if their relevance score is above a threshold. Further, in some embodiments, the context object information matching procedure 338 may only select one relevant object for the potential placement space.

The context-aware object selection procedure 330 transmits an indication of the set of relevant objects to the image processing procedure 320.

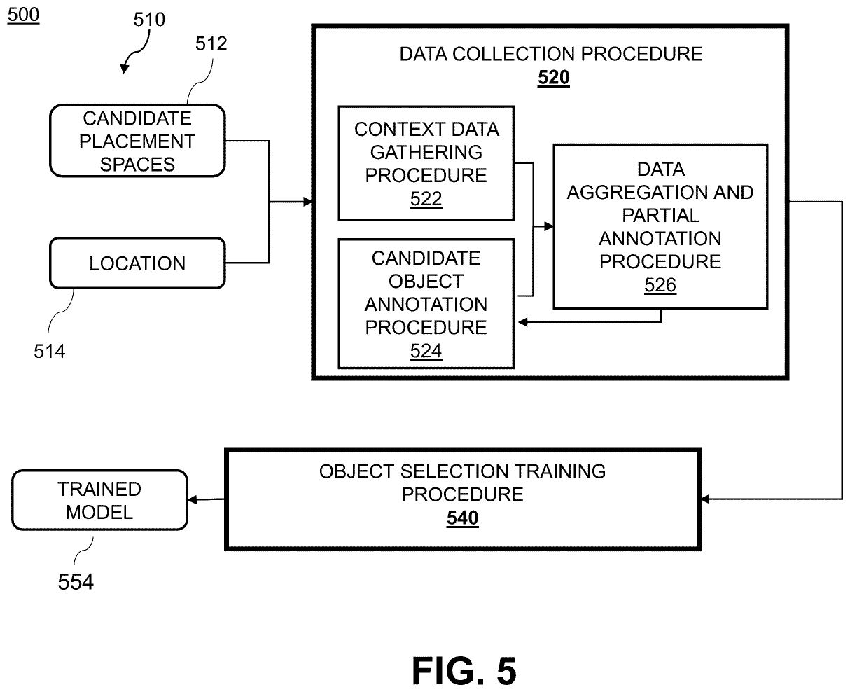

Having explained how the contextualized object placement procedure 300 provides relevant objects for display on placement spaces based on contextual information, the training of the context-aware object selection procedure 330 will now be explained in more detail with reference to FIG. 5, which shows a schematic diagram of a data annotation and training procedure 500 in accordance with one or more non-limiting embodiments of the present technology.

Data Annotation and Training Procedure

The data annotation and training procedure 500 is used for inter alia aggregating data for training ML models to perform the contextualized object placement procedure 300.

The data annotation and training procedure 500 comprises inter alia a data collection procedure 520 and an object selection training procedure 540.

The data annotation and procedure 500 is configured to inter alia: (i) receive inputs 510 comprising a candidate placement space 512 and location 514; (ii) perform, based on the inputs 510, a data collection procedure 520 to obtain annotated objects; (iii) store the annotated objects in the first database 225; and (iv) perform an object selection training procedure 540 to train the matching ML model 260 based on the annotated objects and categories to output a trained matching ML model 554.

The data annotation and procedure 500 receive inputs 510 comprising a candidate placement space 512 and location 514. It will be appreciated that the number of candidate placement spaces 512 and location 514 is not limited and may include a plurality of locations for which candidate placement space and user information is provided.

The location in the location data 514 may include a latitude and a longitude. In one or more embodiments, the location may be in the form of GPS coordinates. In one or more other embodiments, the location may be relative to predetermined objects and/or structures on a map.

In one or more embodiments, the location data 514 may be relative to the location coordinates of a DOOH billboard, such as the DOOH interface 214. This also applies to the context of contextualized object placement within mobile applications (e.g., mobile application executed by the client device 210 or electronic device 100).

In one or more embodiments, the candidate placement spaces 512 may be obtained via the image processing procedure 320. The candidate placement space 512 corresponds to a placement space in proximity of the location in the location 514.

In one or more alternative embodiments, the candidate placement spaces 512 may be obtained from a database connected to the server 220 such as the first database 225. In one or more embodiments, the candidate placement spaces 512 are received based on at least location 514.

In one or more other embodiments, the candidate placement space 512 comprises one or more images of the candidate placement space 512. In such embodiments, the candidate features may include image features, including deep features extracted by a feature extraction ML model (not illustrated), also referred to as a feature extractor. The feature extractor may be based on convolutional neural networks (CNNs) and include, as a non-limiting example, models such as ResNet, ImageNet, GoogleNet and AlexNet.

The data collection procedure 520 comprises a context data gathering procedure 522, a candidate object annotation procedure 524 and data aggregation and annotation procedure 526.

The context data gathering procedure 522 is configured to obtain, from the one or more support information source 332, contextual information related to the location data 514.

The contextual information related to the location has been described with reference to FIG. 3 above. The contextual information may be associated with a set of contextual features, i.e., metadata related to the instance of contextual information.

The contextual information may include one or more of weather conditions, structures in proximity of the at least one location, points of interest (POI) in proximity of the at least one location, traffic in proximity of the at least one location, events in proximity of the at least one location.

In one or more alternative embodiments, the contextual information may comprise information about the size and shape nearby buildings, structures, surrounding placement spaces, information on nearby natural or manmade objects and the like.

The candidate object annotation procedure 524 is configured to inter alia: (i) receive the plurality of objects, contextual information, and the candidate placement space 512; and (ii) transmit the objects, contextual information and candidate placement space 512 for annotation to annotators.

In one or more embodiments, an indication of the plurality of objects, contextual information, and the candidate placement space 512 are transmitted to annotators for annotation.

Additionally, in alternative embodiments, object features and placement space features may be transmitted together with the objects for annotation.

The annotators may annotate the objects by selecting objects that would be relevant to be displayed on the candidate placement space 512 given the contextual information. In one or more alternative embodiments, the annotators may give a score to the objects based on the perceived relevance of the object to the context.

It will be appreciated that a given annotator may be equipped with an augmented reality enabled client device 218 and may go to the location such that the given user may see the object overlaid on the placement space when performing the annotation. Alternatively, the objects may be overlaid on the placement spaces in images and may be rated by the respective annotator (e.g., users 216 of the client devices 218).

An indication of the selected objects is transmitted by each annotator client device to the data aggregation and partial annotation procedure 526.

In one or more embodiments, the device on which the candidate object annotation procedure 524 is executed may have a display interface and input/output interface accessible to the group of annotators for annotation of the objects. In such embodiments, the annotator may annotate the objects using the input/output interface (i.e., keyboard, touchscreen) of the device to provide the set of selected or annotated objects.

The data aggregation and partial annotation procedure 526 is configured to receive, from at least one annotator client device, a set of annotated objects having been selected from a plurality of objects. In one or more embodiments, the annotated objects and corresponding placement spaces may be stored in the first database 225.

The object selection training procedure 540 is configured to inter alia: (i) initialize the matching ML model 260; (ii) receive the plurality of objects; (iii) receive location 514 and contextual information; (iv) receive the candidate placement space 512; (v) receive annotated objects, contextual information, and placement space; (vi) train one or more matching ML model 260 to perform relevant objects category selection based on object features, contextual information, and placement space; select, based on the annotated objects categories, a set of objects from the plurality of objects belonging to the annotated relevant objects and by using the annotated objects as a target; and (vii) output the trained matching ML model.

In one or more embodiments, one or more of the matching ML models 260 may be trained using a combination of collaborative filtering and contextual objects similarity embedding techniques.

In one or more embodiments, the matching ML models 260 may be implemented as matching networks.

The training of the matching ML models 260, which relies on annotated contexts containing relevant objects and their respective categories, is divided into two main steps. The first step involves learning to predict the relevant object category. In the second step, the ML models 260 learns to predict the relevant object from a set of objects belonging to the annotated relevant category while considering the gathered contextual information.

For the relevant object category selection, the training set comprises, N objects categories and K contextual information and placement space attributes. The classification model here is trained to maximize the accuracy of predicting the best category of objects while considering the features of the provided contextual information and placement space samples. Thus, the classification network learns the ability to solve a classification problem on unseen context information and placement space.

After that, for each predicted relevant objects category, the following procedure is applied: each object from the set of objects belonging to the predicted relevant objects category is individually input to the hybrid object selection model. This model seamlessly integrates collaborative filtering and contextual object similarity embedding techniques to make informed and accurate contextual objects selection.

The matching ML models 260 are configured to match one or more of object features, location features, contextual features, and optionally placement space features in images to select relevant objects for display.

The data annotation and training procedure 500 outputs at least one trained matching ML model 554. The at least one trained matching ML model 554 has learned to select relevant objects for display on a placement space based on one or more of object features, contextual information, location, and placement space features.

The trained matching ML model 554 can be effectively utilized not only within the MR environment for context-aware object selection, as described above, but can be also applicable to facilitate object placement in various contexts, including mobile applications and DOOH scenarios.

It will be appreciated that the trained matching ML model 554 may be stored in a storage medium, such as a memory of the server 220 or the first database 225. The trained matching ML model 554 may be transmitted for use by another server or client device (not illustrated).

Method Description

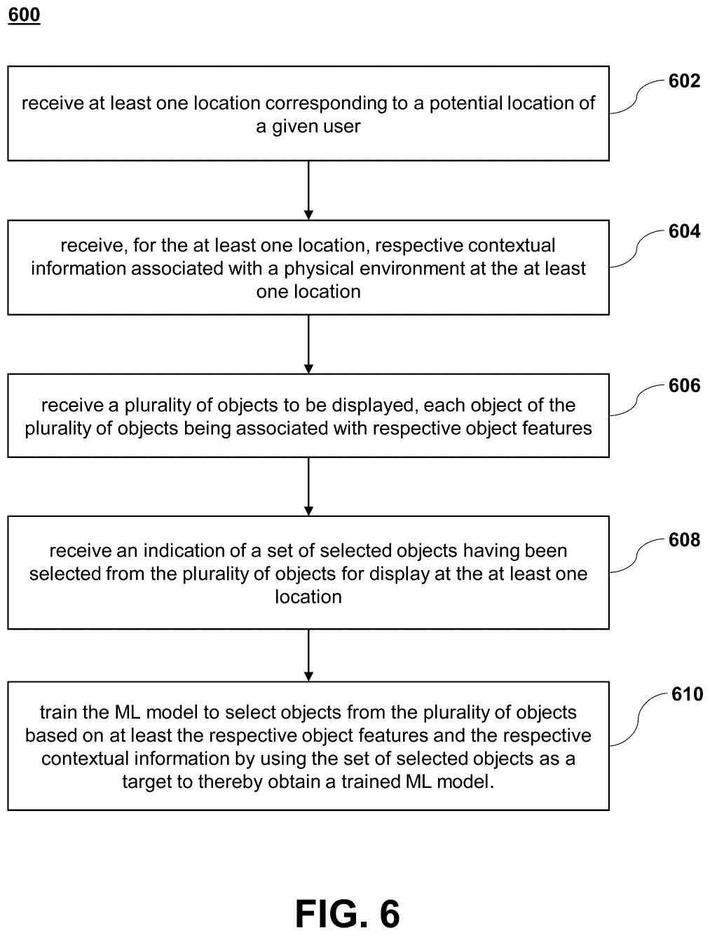

FIG. 6 illustrates a flowchart of a method 600 for training a machine learning (ML) model for performing contextual object matching to display objects in a mixed reality (MR) environment in real-time in accordance with one or more non-limiting embodiments of the present technology.

In one or more embodiments, the server 220 comprises at least one processing device such as the processor 110 and/or the GPU 111 operatively connected to a non-transitory computer readable storage medium such as the solid-state drive 120 and/or the random-access memory 130 storing computer-readable instructions. The at least one processing device, upon executing the computer-readable instructions, is configured to or operable to execute the method 600.

The method 600 begins at processing step 602.

At processing step 602, the processor 110 receives at least one location corresponding to a potential location of a given user.

In one or more embodiments, the at least one location comprises a plurality of locations, each location corresponding to a respective potential location of a respective user.

At processing step 604, the at least one processing device receives, for the at least one location, respective contextual information associated with the at least one location, the respective contextual information being indicative of a context in a physical environment of the at least one location.

In one or more embodiments, the contextual information comprises at least one of: weather conditions, structures in proximity of the at least one location, points of interest (POI) in proximity of the at least one location, traffic in proximity of the at least one location, events in proximity of the at least one location.

In one or more embodiments, the contextual information is associated with contextual features comprising a category of the contextual information and the training of the ML model is further based on the contextual features.

At processing step 606, the at least one processing device receives a plurality of objects to be displayed, each object of the plurality of objects being associated with respective object features.

In one or more embodiments, the respective object features comprise a respective title of the respective object, a respective description of the respective object, and a respective category of the respective object. In some implementations, the respective object features further comprise a respective size of the respective object and a respective color of the respective object.

In one or more embodiments, the respective object features comprise at least one of: a respective size of the object, a respective color of the object.

At processing step 608, the at least one processing device receives an indication of a set of selected objects having been selected from the plurality of objects for display at the respective location.

In one or more embodiments, prior to processing step 608, the at least one processing device further transmits, to at least one client device connected to the at least one processing device, the plurality of objects, the at least one location and the respective contextual information for annotation by a user associated with the client device.

In one or more embodiments, prior to processing step 608, the at least one processing device receives, for the at least one location, at least one candidate placement space for displaying objects thereon, the at least one candidate placement space being associated with respective placement space features. The at least one processing device then transmits, to the client device, the at least one candidate placement space for consideration by the user when selecting the set of objects.

In one or more embodiments, the training of the matching ML model 260 is further based on the candidate features of the at least one candidate placement space.

At processing step 610, the at least one processing device trains the matching ML model 260 to select objects from the plurality of objects based on the respective object features, the respective contextual information, and the respective location by using the set of selected objects as a target to thereby obtain a trained ML model.

In one or more embodiments, the training of the matching ML model 260 is performed using a combination of collaborative filtering and contextual objects similarity embedding techniques.

In one or more embodiments, matching ML model 260 comprises a matching network.

The method 600 then ends.

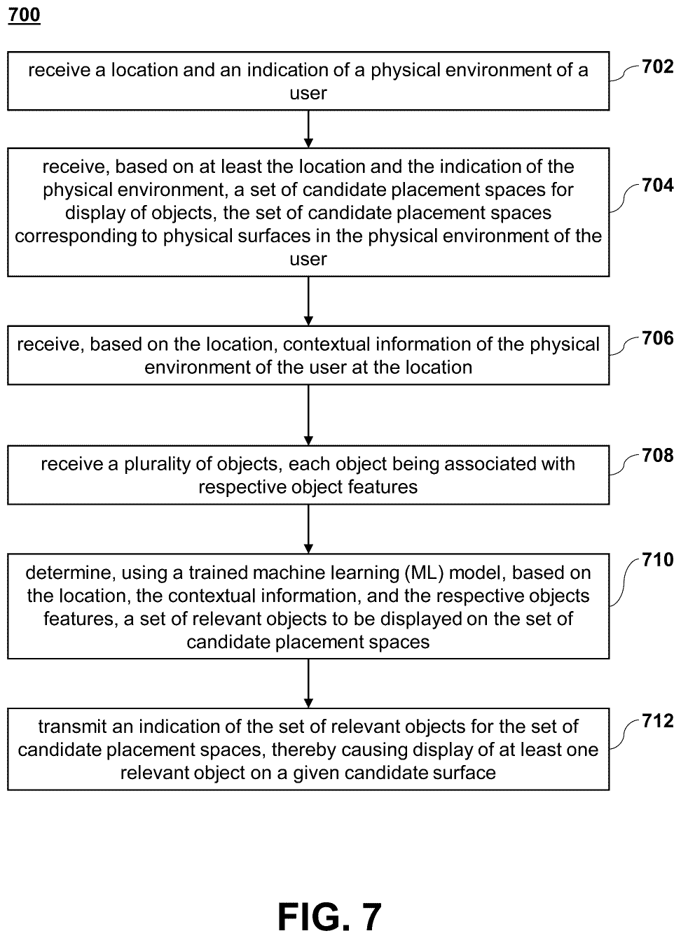

FIG. 7 illustrates a flowchart of a method 700 for selecting objects for display on a placement space in a mixed reality (MR) environment in real-time in accordance with one or more non-limiting embodiments of the present technology.

The method 700 may be executed after the method 600. In some implementations, the method 700 may be executed by the server 220. In one or more other implementations, the method 700 may be executed by a client device, such as one of the client devices 210, 211.

In one or more embodiments, the server 220 comprises at least one processing device such as the processor 110 and/or the GPU 111 operatively connected to a non-transitory computer readable storage medium such as the solid-state drive 120 and/or the random-access memory 130 storing computer-readable instructions. The at least one processing device, upon executing the computer-readable instructions, is configured to or operable to execute the method 700. It will be appreciated that the method 700 may be executed by a processing device different from the processing device executing the method 600.

The method 700 is executed in real time.

The method 700 begins at processing step 702.

At processing step 702, the at least one processing device receives a location and an indication of a physical environment of a user.

At processing step 704, the at least one processing device receives, based on at least the location and the indication of the physical environment, a set of candidate placement spaces for display of objects, the candidate placement space corresponding to physical placement spaces in the physical environment of the user.

The set of candidate placement spaces comprises at least one candidate placement space. Each of the set of candidate placement spaces is associated with respective placement space features.

At processing step 706, the at least one processing device receives, based on the location, contextual information of the physical environment of the user at the location.

In one or more implementations, the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location. In some implementations, the contextual information is associated with contextual features comprising a category of the contextual information.

At processing step 708, the at least one processing device receives a plurality of objects, each object being associated with respective object features.

The respective object features comprise at least one of: respective title of the object, a respective description of the object, and a respective category of the object. In one or more implementations, the respective object features further comprise at least one of: a respective size of the object and a respective color of the object.

At processing step 710, the at least one processing device determines, using a trained matching ML model 260, based on the location, the contextual information, and the respective objects features, a set of relevant objects to be displayed on the candidate placement space.

In one or more implementations, the trained matching ML model 260 has been trained by executing method 600.

At processing step 712, the at least one processing device transmits an indication of the set of relevant objects for the candidate placement space, thereby causing display of at least one relevant object on a given candidate placement space.

The method 700 then ends.

It should be apparent to those skilled in the art that at least some embodiments of the present technology aim to expand a range of technical solutions for addressing a particular technical problem, namely selecting automatically objects for a given context, which may prevent relying on human decision and save computational resources.

It should be expressly understood that not all technical effects mentioned herein need to be enjoyed in each and every embodiment of the present technology. For example, embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

What is claimed is:

1. A method for training a machine learning (ML) model for performing contextual object matching to display objects in real-time in a digital environment, the method being executed by at least one processing device, the method comprising:
receiving at least one location corresponding to a potential location of a given user;
receiving, for the at least one location, respective contextual information associated with a physical environment at the at least one location;
receiving a plurality of objects to be displayed, each object of the plurality of objects being associated with respective object features;
receiving an indication of a set of selected objects having been selected from the plurality of objects for display at the at least one location; and
training the ML model to select objects from the plurality of objects based on at least the respective object features and the respective contextual information by using the set of selected objects as a target to thereby obtain a trained ML model.

2. The method of claim 1, further comprising, prior to said receiving the indication of the set of objects having been selected from the plurality of objects for display at the given location, transmitting, to at least one client device connected to the at least one processing device, the plurality of objects, the at least one location and the respective contextual information for annotation by a user associated with the client device.

3. The method of claim 2, further comprising, prior to said receiving the indication of the set of objects having been selected from the plurality of objects for display at the given location:
receiving, for the at least one location, at least one candidate placement space for displaying objects thereon, the at least one candidate placement space being associated with respective placement space features; and
transmitting, to the client device, at least one candidate placement space for consideration when selecting the set of objects.

4. The method of claim 3, wherein said training of the ML model is further based on the candidate features of at least one candidate placement space.

5. The method of claim 4, wherein the respective object features comprise at least one of: a respective title of the object, a respective description of the object, and a respective category of the object.

6. The method of claim 5, wherein the respective object features comprise at least one of: a respective size of the object and a respective color of the object.

7. The method of claim 6, wherein the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location.

8. The method of claim 7, wherein:
the contextual information is associated with contextual features comprising a category of the contextual information, and
said training of the ML model is further based on the contextual features.

9. The method of claim 6, wherein said training of the ML model is performed using a hybrid model combining collaborative filtering and contextual objects similarity embedding techniques.

10. A method for selecting objects for display on a placement space in a mixed reality (MR) environment in real-time, the method being executed by at least one processing device, the method comprising:
receiving a location and an indication of a physical environment of a user;
receiving, based on at least the location and the indication of the physical environment, a set of candidate placement spaces for display of objects, the set of candidate placement spaces corresponding to physical placement spaces in the physical environment of the user;
receiving, based on the location, contextual information of the physical environment of the user at the location;
receiving a plurality of objects, each respective object being associated with respective object features;
determining, using a trained machine learning (ML) model, based on the location, the contextual information, and the respective objects features, a set of relevant objects to be displayed on the set of candidate placement spaces; and
transmitting an indication of the set of relevant objects for the set of candidate placement spaces, thereby causing display of at least one relevant object on a given candidate placement space.

11. The method of claim 10, wherein the respective object features comprise at least one of: a respective title of the respective object, a respective description of the respective object, and a respective category of the respective object.

12. The method of claim 11, wherein the respective object features comprise at least one of: a respective size of the respective object and a respective color of the respective object.

13. The method of claim 12, wherein the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location.

14. The method of claim 13, wherein:
the contextual information is associated with contextual features comprising a category of the contextual information, and
said determining, using the trained machine learning (ML) model, based on the location, the contextual information, and the respective objects features, the set of relevant objects to be displayed on the set of candidate placement spaces is further based on the contextual features.

15. A system for selecting objects for display on a placement space in a mixed reality (MR) environment in real-time, the system comprising:
at least one processing device; and
a non-transitory storage medium operatively connected to the at least processing device, the non-transitory storage medium storing computer-readable instructions thereon;
wherein the at least one processing device, upon executing the computer-readable instructions, is configured to:
receive a location and an indication of a physical environment of a user;
receive, based on at least the location and the indication of the physical environment, a set of candidate placement spaces for display of objects, the candidate placement space corresponding to physical placement spaces in the physical environment of the user;
receive, based on the location, contextual information of the physical environment of the user at the location;
receive a plurality of objects, each respective object being associated with respective object features;
determine, using a trained machine learning (ML) model, based on the location, the contextual information, and the respective objects features, a set of relevant objects to be displayed on the set of candidate placement spaces; and
transmit an indication of the set of relevant objects for the set of candidate placement spaces, thereby causing display of at least one relevant object on a given candidate placement space.

16. The system of claim 15, wherein the respective object features comprise at least one of: a respective title of the respective object, a respective description of the respective object, and a respective category of the respective object.

17. The system of claim 16, wherein the respective object features comprise at least one of: a respective size of the respective object and a respective color of the respective object.

18. The system of claim 16, wherein the contextual information comprises at least one of: weather conditions, structures in proximity of the at least one location, points of interest (POI) in proximity of the at least one location, traffic in proximity of the at least one location, special offers in proximity of the at least one location, and events in proximity of the at least one location.

19. The system of claim 18, wherein:
the contextual information is associated with contextual features comprising a category of the contextual information, and
the at least one processing device is further configured to determine, using the trained machine learning (ML) model, based on the location, the contextual information, and the respective objects features, the set of relevant objects to be displayed on the candidate placement space is further based on the contextual features.

20. The system of claim 19, wherein the trained ML model comprises a hybrid model combining collaborative filtering and contextual objects similarity embedding techniques.
